(19) United States
(12) Patent Application Publication
(10) Pub. No.: US 2026/0369602 A1
(43) Pub. Date: Nov. 19, 2026

(54) NEGATIVE ELECTRODE PLATE FOR NON-AQUEOUS ELECTROLYTE SECONDARY BATTERY AND METHOD FOR PRODUCING THE SAME

(71) Applicant: Prime Planet Energy & Solutions, Inc., Tokyo (JP)

(72) Inventor: Surim KANG, Kobe-shi, Hyogo (JP)

(21) Appl. No.: 19/674,127

(22) Filed: May 12, 2026

(30) Foreign Application Priority Data
May 16, 2025 (JP) 2025-082329

(51) Int. Cl. H01M 4/587; H01M 4/02; H01M 4/04; H01M 10/0525

(52) U.S. Cl. CPC H01M 4/587; H01M 4/043; H01M 10/0525; H01M 2004/021; H01M 2004/027

(57) ABSTRACT

Provided is a negative electrode plate for a non-aqueous electrolyte secondary battery, the negative electrode plate comprising a negative electrode composite material layer, wherein the negative electrode composite material layer includes an active material, the active material includes silicon-containing particles and graphite particles, a content of the silicon-containing particles in the active material relative to a total mass of the active material is from 10 to 60 mass %, the silicon-containing particles have a powder density of 0.90 g/cm³ or less when uniaxially compacted at a shaping pressure of up to 60 MPa, and a shaping pressure required for uniaxially compacting the graphite particles to a density of 1.7 g/cm³ is 30 MPa or more.

### CROSS REFERENCE TO RELATED APPLICATIONS

This nonprovisional application is based on Japanese Patent Application No. 2025-082329 filed on May 16, 2025, with the Japan Patent Office, the entire contents of which are hereby incorporated by reference.

### BACKGROUND OF THE INVENTION

### Field of the Invention

The present disclosure relates to a negative electrode plate for a non-aqueous electrolyte secondary battery, and it also relates to a method of producing the same.

### Description of the Background Art

Japanese Patent Laying-Open No. 2024-159006 discloses a negative electrode material containing Si-containing particles and graphite particles, in which when a pressure of 60 MPa is uniaxially applied to 1 g of the Si-containing particles at 25 °C to form a tablet having a diameter of 20 mm, the resulting green body has a density of 0.9 g/cm³ or more.

### SUMMARY OF THE INVENTION

In a configuration where the content of Si-based active material is high in the negative electrode plate, after the negative electrode composite material layer is compressed during manufacturing of the negative electrode plate, the volume of the Si-based active material increases to a great extent during charging of the non-aqueous electrolyte secondary battery containing the negative electrode plate, which means a decrease of pores inside the negative electrode composite material layer and the electrode assembly and potentially a decrease of the flow of electrolyte solution inside the negative electrode composite material layer and the electrode assembly. As a result, the resistance of the non-aqueous electrolyte secondary battery tends to increase.

An object of the present disclosure is to provide a negative electrode plate for a non-aqueous electrolyte secondary battery in which an increase of resistance is reduced, as well as a method of producing the same.

[1] A negative electrode plate for a non-aqueous electrolyte secondary battery, the negative electrode plate comprising:
a negative electrode composite material layer, wherein
the negative electrode composite material layer includes an active material,
the active material includes silicon-containing particles and graphite particles,
a content of the silicon-containing particles in the active material relative to a total mass of the active material is from 10 to 60 mass %,
the silicon-containing particles have a powder density of 0.90 g/cm³ or less when uniaxially compacted at a shaping pressure of up to 60 MPa, and
a shaping pressure required for uniaxially compacting the graphite particles to a density of 1.7 g/cm³ is 30 MPa or more.

[2] The negative electrode plate for a non-aqueous electrolyte secondary battery according to [1], wherein a ratio of an average particle size D50 of the graphite particles to an average particle size D50 of the silicon-containing particles is from 1.00 to 8.00.

[3] The negative electrode plate for a non-aqueous electrolyte secondary battery according to [1] or [2], wherein an average particle size D50 of the graphite particles is from 5 to 25 μm, and an average particle size D50 of the silicon-containing particles is from 2 to 25 μm.

[4] The negative electrode plate for a non-aqueous electrolyte secondary battery according to any one of [1] to [3], wherein a content of the graphite particles in the active material relative to the total mass of the active material is from 40 to 85 mass %.

[5] The negative electrode plate for a non-aqueous electrolyte secondary battery according to any one of [1] to [4], wherein a silicon content of the silicon-containing particles is from 20 mass % to 60 mass %.

[6] The negative electrode plate for a non-aqueous electrolyte secondary battery according to any one of [1] to [5], wherein the negative electrode composite material layer has a density of 1.3 g/cm³ or more.

[7] A non-aqueous electrolyte secondary battery comprising the negative electrode plate for a non-aqueous electrolyte secondary battery according to any one of [1] to [6].

[8] A method of producing a negative electrode plate for a non-aqueous electrolyte secondary battery, the method comprising:
compressing a negative electrode composite material layer including an active material, wherein
the active material includes silicon-containing particles and graphite particles,
a content of the silicon-containing particles in the negative electrode composite material layer relative to a total mass of the active material is from 10 to 60 mass %,
the silicon-containing particles have a powder density of 0.9 g/cm³ or less when uniaxially compacted at a shaping pressure of up to 60 MPa, and
a shaping pressure required for uniaxially compacting the graphite particles to a density of 1.7 g/cm³ is 30 MPa or more.

[9] The method of producing a negative electrode plate for a non-aqueous electrolyte secondary battery according to [8], the method further comprising:
preparing a negative electrode composite material paste; and
forming the negative electrode composite material layer by applying the negative electrode composite material paste to a negative electrode base material and drying.

[10] The method of producing a negative electrode plate for a non-aqueous electrolyte secondary battery according to [8] or [9], wherein a ratio of an average particle size D50 of the graphite particles to an average particle size D50 of the silicon-containing particles is from 1.00 to 8.00.

[11] The method of producing a negative electrode plate for a non-aqueous electrolyte secondary battery according to any one of [8] to [10], wherein an average particle size D50 of the graphite particles is from 5 to 25 μm, and an average particle size D50 of the silicon-containing particles is from 2 to 25 μm.

[12] The method of producing a negative electrode plate for a non-aqueous electrolyte secondary battery according to any one of [8] to [11], wherein a content of the graphite particles in the active material relative to the total mass of the active material is from 40 to 85 mass %.

[13] The method of producing a negative electrode plate for a non-aqueous electrolyte secondary battery according to any one of [8] to [12], wherein a silicon content of the silicon-containing particles relative to the mass of the silicon-containing particles is from 20 mass % to 60 mass %.

The foregoing and other objects, features, aspects and advantages of the present invention, when taken in conjunction with the accompanying drawings will become more apparent from the following detailed description of the present invention.

### BRIEF DESCRIPTION OF THE DRAWINGS

FIG. 1 is a schematic cross-sectional view illustrating a negative electrode plate.

FIG. 2 is a schematic cross-sectional view illustrating an example of a non-aqueous electrolyte secondary battery.

FIG. 3 is a schematic view illustrating an example of an electrode assembly.

FIG. 4 is a schematic flowchart illustrating a method of producing a negative electrode plate.

### DESCRIPTION OF THE PREFERRED EMBODIMENTS

### <Negative Electrode Plate for Non-Aqueous Electrolyte Secondary Battery>

A negative electrode plate for a non-aqueous electrolyte secondary battery (hereinafter also referred to as a negative electrode plate) according to the present disclosure is used in a non-aqueous electrolyte secondary battery. The non-aqueous electrolyte secondary battery may be a lithium-ion secondary battery, for example.

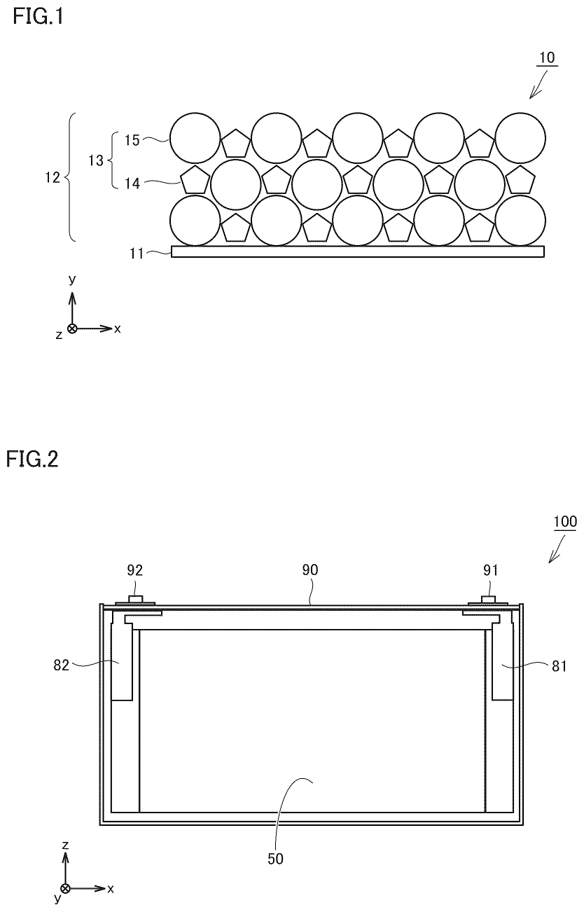

The negative electrode plate comprises a negative electrode composite material layer including an active material. As illustrated in FIG. 1, in a negative electrode plate 10, a negative electrode composite material layer 12 may be formed directly or indirectly on one side or both sides of a negative electrode base material 11. Negative electrode base material 11 may be a conductive sheet made of copper (Cu) foil, nickel (Ni) foil, titanium (Ti) foil, stainless steel foil, and/or the like, for example, and preferably it is a copper foil sheet.

Negative electrode composite material layer 12 includes an active material 13. Active material 13 includes silicon-containing particles (Si-containing particles) 14 and graphite particles 15. Active material 13 can further include metal-based active material particles including an element selected from the group consisting of tin (Sn), antimony (Sb), bismuth (Bi), Ti, germanium (Ge), and the like, for example, carbon-based active material particles other than graphite, and/or the like. Active material 13 can consist solely of Si-containing particles 14 and graphite particles 15.

The powder density of Si-containing particles 14 when uniaxially compacted at a shaping pressure of up to 60 MPa (hereinafter also referred to as the powder density) is 0.90 g/cm³ or less. “Uniaxially” in the context of powder density means that in order to measure powder density, a shaping pressure of 60 MPa is applied to a powder sample placed in a tubular vessel, in the height direction (one direction) of the tubular vessel. In the powder density measurement, the shaping pressure required for uniaxially compacting graphite particles 15 to a density of 1.7 g/cm³ (hereinafter also referred to as the required shaping pressure) is 30 MPa or more. “Uniaxially” in the context of required shaping pressure means that in order to measure powder density, a shaping pressure is applied to a powder sample placed in a tubular vessel, in the height direction (one direction) of the tubular vessel. When Si-containing particles having a powder density within the above-mentioned range and graphite particles having a required shaping pressure within the above-mentioned range are used in combination, in other words, when graphite with low compactibility and Si-based active material with low compactibility are mixed, pores inside the negative electrode composite material layer are maintained even after the negative electrode composite material layer is compressed, and thereby flow of electrolyte solution inside the negative electrode plate and inside the electrode assembly tends to be maintained, which tends to achieve a relatively low resistance of the non-aqueous electrolyte secondary battery.

From the viewpoint of the resistance of the non-aqueous electrolyte secondary battery, the powder density of Si-containing particles 14 is preferably 0.85 g/cm³ or less, more preferably 0.80 g/cm³ or less. For example, the powder density of Si-containing particles 14 may be 0.70 g/cm³ or more, or 0.75 g/cm³ or more. The powder density of Si-containing particles 14 can be measured by a method described below in the Examples section.

The powder density of Si-containing particles 14 can be controlled by adjusting the average particle size D50 and the composition (the proportion of constituent elements) of Si-containing particles 14, the amount of pores inside the Si-containing particles, and/or the like, for example.

Si-containing particles 14 may be a Si—C composite material, for example. The Si—C composite material can be composed of a carbon domain and a Si-containing domain. In the Si—C composite material, a plurality of Si-containing domains may be dispersed in a matrix carbon domain. The Si-containing domain may be composed of Si, Si oxide (SiOₓ), Si nitride (SiNₓ), Si carbide (SiCₓ), and/or the like, for example. Preferably, the Si-containing domain is composed of at least one of Si and Si oxide (SiOₓ). When the Si—C composite material is composed of a plurality of Si-containing domains dispersed in a matrix carbon domain, the carbon domain can advantageously absorb the volume change caused by expansion and shrinkage of the Si-containing domains.

Each Si-containing domain may be a microparticle. When each Si-containing domain is a microparticle, the average particle size of the Si-containing domains is 50 nm or less, for example, and it may be from 5 nm to 50 nm. The average particle size of the Si-containing domains is determined as follows: the negative electrode composite material layer is subjected to focused ion beam (FIB) processing; the STEM examination sample thus obtained is subjected to EDX elemental mapping for elemental analysis; based on the contrast and shape obtained from a BF image (a bright field image) and an HAADF image (a high-angle annular dark field image), the diameters of the Si-containing domains are determined; and the average value of the diameters of ten or more randomly-selected Si-containing domains is regarded as the average particle size.

The carbon domain may be a carbonized product of a carbon precursor (such as petroleum pitch, coal pitch, phenolic resin, and/or the like), graphite, and the like, for example.

The Si content of Si-containing particles 14 is not particularly limited. From the viewpoint of the capacity of the non-aqueous electrolyte secondary battery, the Si content of Si-containing particles 14 is preferably 20 mass % or more, more preferably 30 mass % or more, further preferably 40 mass % or more. From the viewpoint of reducing the volume change of Si-containing particles 14, the Si content of Si-containing particles 14 is preferably 60 mass % or less, more preferably 50 mass % or less. The oxygen (O) content of Si-containing particles 14 is not particularly limited, and, preferably, it is 10 mass % or less. The Si content and the O content of Si-containing particles 14 can be determined by analysis based on high-frequency inductively coupled plasma (ICP) emission spectroscopy.

Si-containing particle 14 may be, for example, a Si-containing microparticle dispersed inside a carbon material, a Si-containing microparticle penetrated inside a pore of spherically-granulated porous graphite, a Si-containing microparticle adhered to the surface of a carbon particle, a carbon microparticle adhered to the surface of a Si-containing particle, and/or the like. Si-containing particles 14 may be coated, for example, and they may be coated with Si.

For example, Si-containing particles 14 can be obtained by mixing microparticles of Si, Si oxide, and/or the like with the above-mentioned carbon precursor and then carbonizing and spheroidizing the resultant. Alternatively, spherically-granulated porous graphite and microparticles of Si, Si oxide, and/or the like can be mixed in a dispersion medium and dried to have the microparticles placed inside the pores of the porous graphite.

Moreover, the Si-containing particles may be, for example, a composite with an element except carbon, or may be metal Si particles, Si oxide particles, and/or the like, which are not a composite with other elements.

Si-containing particles 14 can be produced by a conventionally known method.

The average particle size D50 of Si-containing particles 14 is from 2 μm to 25 μm, for example, and from the viewpoint of the resistance of the non-aqueous electrolyte secondary battery, it is preferably from 2 to 15 μm, more preferably from 5 μm to 10 μm. Herein, the average particle size D50 refers to a median diameter (D50), and it means a particle size in volume-based particle size distribution based on laser diffraction and scattering at which cumulative frequency accumulated from the small particle size side reaches 50 volume %. The average particle size D50 can be determined with a laser diffraction and scattering particle size distribution measuring apparatus and/or the like.

The content of Si-containing particles 14 in active material 13 relative to the total mass of active material 13 is from 10 to 60 mass %. When active material 13 contains Si-containing particles 14 at a content within the above-mentioned range, an increase of the resistance of the non-aqueous electrolyte secondary battery tends to be reduced. From the viewpoint of the resistance of the non-aqueous electrolyte secondary battery, the content of Si-containing particles 14 in active material 13 is preferably from 20 to 55 mass %, more preferably from 25 to 50 mass %, further preferably from 30 to 45 mass %.

From the viewpoint of the resistance of the non-aqueous electrolyte secondary battery, the required shaping pressure for graphite particles 15 is preferably 35 MPa or more, more preferably 40 MPa or more, further preferably 45 MPa or more, and, for example, it is 50 MPa or less. The required shaping pressure for graphite particles 15 can be measured by a method described below in the Examples section.

The required shaping pressure for graphite particles 15 can be controlled by, for example, adjusting the average particle size D50 of graphite particles 15, the physical properties (hardness, shape, and/or the like) of the carbon, the amount and physical properties of the coating, and/or the like.

The graphite constituting the graphite particles 15 may be either natural graphite or artificial graphite, and it may be amorphous-carbon-coated graphite which is graphite coated with an amorphous carbon material.

The average particle size D50 of graphite particles 15 is from 5 to 25 μm, for example, and from the viewpoint of the resistance of the non-aqueous electrolyte secondary battery, it is preferably from 10 to 20 μm, more preferably from 18 to 20 μm.

The content of graphite particles 15 in active material 13 relative to the total mass of active material 13 may be from 40 to 90 mass %, for example, and from the viewpoint of the resistance of the non-aqueous electrolyte secondary battery, it is preferably from 40 to 85 mass %, more preferably from 45 to 83 mass %, further preferably from 50 to 80 mass %.

From the viewpoint of the resistance of the non-aqueous electrolyte secondary battery, the ratio of the average particle size D50 of graphite particles 15 to the average particle size D50 of the Si-containing particles, namely (graphite particles/Si-containing particles), is preferably from 1.00 to 8.00, more preferably from 1.50 to 5.00, further preferably from 2.00 to 3.00.

Negative electrode composite material layer 12 may further include a conductive material, a binder, and the like. Examples of the conductive material include carbon blacks such as carbon nanotubes (CNTs) and acetylene black (AB), other carbon materials (such as graphite), and the like, for example. Examples of the binder include polyvinylidene difluoride (PVdF), polytetrafluoroethylene (PTFE), polyimide (PI), polyamide (PA), polyacrylic acid (PAA), polyamide-imide (PAI), butadiene rubber (BR), styrene-butadiene rubber (SBR), nitrile-butadiene rubber (NBR), styrene-ethylene-butylene-styrene block copolymer (SEBS), carboxymethylcellulose (CMC), combinations of these, and the like, for example.

The content of active material 13 in negative electrode composite material layer 12 relative to the mass of negative electrode composite material layer 12 may be 90 mass % or more, for example, and it is preferably 95 mass % or more; and it may be 100 mass % or less, for example. The content of the binder in negative electrode composite material layer 12 may be from 0.1 to 8.0 mass %, or from 0.5 to 5.0 mass %, for example. The content of the conductive material in negative electrode composite material layer 12 may be from 0.01 to 3.0 mass %, or from 0.05 to 1.0 mass %, for example.

The thickness of negative electrode composite material layer 12 is from 10 μm to 400 μm, for example, and it is preferably from 20 μm to 300 μm.

The density of negative electrode composite material layer 12 may be 1.0 g/cm³ or more, for example, and it is preferably 1.1 g/cm³ or more, more preferably 1.3 g/cm³ or more, further preferably 1.4 g/cm³ or more. The density of negative electrode composite material layer 12 may be 2.3 g/cm³ or less, or 2.0 g/cm³ or less, for example. The density of the negative electrode composite material layer mentioned above is the density after compression.

When Si-containing particles 14 and graphite particles 15 having the above-mentioned compactibility are used, a pathway that facilitates electrolyte solution permeation inside the negative electrode plate is formed. As a result, an increase of the resistance of the non-aqueous electrolyte secondary battery tends to be reduced. In the negative electrode plate according to the present disclosure, a pathway that facilitates electrolyte solution permeation inside the negative electrode plate is formed even when the density of the negative electrode composite material layer is 1.4 g/cm³ or more, and as a result, an increase of the resistance of the non-aqueous electrolyte secondary battery tends to be reduced.

### <Method of Producing Negative Electrode Plate>

A method of producing negative electrode plate 10 comprises compressing a negative electrode composite material layer including an active material. To the active material and the negative electrode composite material, the description of active material 13 and negative electrode composite material layer 12 provided above is applied.

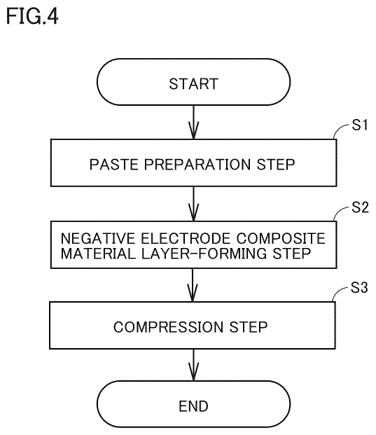

As illustrated in FIG. 4, the method of producing negative electrode plate 10 can include, for example, a paste preparation step (S1) to prepare a negative electrode composite material paste, a negative electrode composite material layer-forming step (S2) to form a negative electrode composite material layer by applying the negative electrode composite material paste to a base material and drying, and a compression step (S3) to compress the negative electrode composite material layer including an active material.

The negative electrode composite material paste is obtained by, for example, mixing graphite, Si-containing particles, and a binder, and then mixing a conductive material and a dispersion solvent, followed by adding a binder and a dispersion solvent and mixing. In the case where the negative electrode composite material paste includes graphite, Si-containing particles, binders which are CMC, PAA, and SBR, as well as CNTs as a conductive material, the following preparation procedure can be employed, for example. Firstly, graphite, Si-containing particles, CMC, and PAA are dry-mixed to form a mixed powder. To the resulting mixed powder, an SWCNT dispersion and a dispersion solvent are added, followed by high-shear kneading and mixing. Subsequently, SBR and a dispersion solvent are further added, followed by dispersing, diluting, and mixing to prepare a negative electrode composite material paste. The dispersion solvent may be an organic solvent, for example, and examples thereof include N-methyl-2-pyrrolidone (NMP), tetrahydrofuran (THF), dimethylformamide (DMF), methyl ethyl ketone (MEK), dimethyl sulfoxide (DMSO), and the like. For the mixing, any suitable stirring apparatus, any suitable mixing apparatus, and/or any suitable dispersing apparatus may be used.

The negative electrode composite material paste is applied to the surface of a negative electrode base material and dried to form a negative electrode composite material layer. The application can be carried out with the use of an application apparatus such as a gravure coater, a comma coater, a slit coater, a die coater, and/or the like, for example. The drying can be carried out by a conventionally known method. In the compression step, the negative electrode composite material layer and the negative electrode base material are compressed to form a negative electrode plate. The compression can be carried out with the use of a roller, for example. The density of the negative electrode composite material layer before the compression step may be less than 1.0 g/cm³, for example. The density of the negative electrode composite material layer after the compression step may be 1.0 g/cm³ or more, for example, and it is preferably 1.1 g/cm³ or more, more preferably 1.3 g/cm³ or more, further preferably 1.4 g/cm³ or more. The negative electrode plate may be cut into a certain planar size according to the specifications of the battery.

### <Non-Aqueous Electrolyte Secondary Battery>

FIG. 2 is a schematic view illustrating an example of a non-aqueous electrolyte secondary battery according to the present embodiment. A battery 100 illustrated in FIG. 2 may be, for example, a lithium-ion battery as a main electric power supply or a motive force assisting electric power supply of an electric vehicle. The non-aqueous electrolyte secondary battery according to the present disclosure includes the above-mentioned negative electrode plate, and thereby an increase of the resistance is reduced.

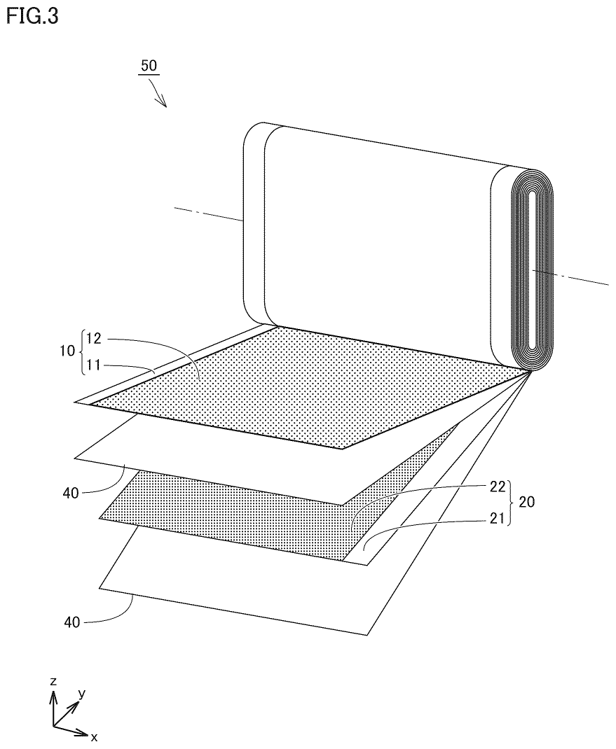

Battery 100 includes an exterior package 90. Exterior package 90 accommodates an electrode assembly 50 and an electrolyte (not illustrated). Electrode assembly 50 is connected to a positive electrode terminal 91 via a positive electrode current-collecting member 81. Electrode assembly 50 is connected to a negative electrode terminal 92 via a negative electrode current-collecting member 82. FIG. 3 is a schematic view illustrating an example of an electrode assembly according to the present embodiment. Electrode assembly 50 is a wound-type one. The electrode assembly may be a stack-type one. Electrode assembly 50 includes a positive electrode plate 20, a separator 40, and negative electrode plate 10. That is, battery 100 includes negative electrode plate 10. Negative electrode plate 10 is the negative electrode plate mentioned above. Positive electrode plate 20 includes a positive electrode composite material layer 22 and a positive electrode base material 21. Negative electrode plate 10 includes negative electrode composite material layer 12 and negative electrode base material 11.

### <Positive Electrode Plate>

The positive electrode plate comprises a positive electrode composite material layer that includes the above-mentioned positive electrode active material. In positive electrode plate 20, positive electrode composite material layer 22 may be formed directly or indirectly on one side or both sides of positive electrode base material 21. Positive electrode base material 21 may be a conductive sheet made of Al alloy foil, pure Al foil, and/or the like, for example. Positive electrode composite material layer 22 may further include a conductive material, a binder, and the like.

Positive electrode composite material layer 22 includes a positive electrode active material. The positive electrode active material may be a positive electrode active material having a known composition that is used in a non-aqueous electrolyte secondary battery. Specifically, the positive electrode active material can be a lithium composite oxide, a lithium-(transition metal) phosphate compound, and/or the like, for example. The crystal structure of the positive electrode active material is not particularly limited, and it may be a layered structure, a spinel structure, an olivine structure, and/or the like.

Preferably, the lithium composite oxide is a lithium-(transition metal) composite oxide including at least one of Ni, Co, and Mn as a transition metal element, and specifically, it may be a lithium-nickel-based composite oxide, a lithium-cobalt-based composite oxide, a lithium-manganese-based composite oxide, a lithium-nickel-manganese-based composite oxide, a lithium-nickel-cobalt-manganese-based composite oxide, a lithium-nickel-cobalt-aluminum-based composite oxide, a lithium-iron-nickel-manganese-based composite oxide, and/or the like.

The thickness of positive electrode composite material layer 22 may be from 10 μm to 200 μm, for example. Positive electrode composite material layer 22 may be dense. The density of positive electrode composite material layer 22 may be 3.65 g/cm³ or more, or 3.7 g/cm³ or more, or 3.8 g/cm³ or more, for example. The density of positive electrode composite material layer 22 may be 4.0 g/cm³ or less, for example.

The content of the positive electrode active material in positive electrode composite material layer 22 is not particularly limited, and, for example, it is 80 mass % or more, preferably 87 mass % or more, more preferably 90 mass % or more, further preferably 95 mass % or more, most preferably 97 mass % or more, relative to the total mass of positive electrode composite material layer 22.

Positive electrode composite material layer 22 may include a component other than the positive electrode active material, such as a conductive material, a binder, and/or the like, for example. To the conductive material and the binder, the description provided above is applied.

Separator 40 has a monolayered or multilayered base material, and on at least one side of the base material, a functional layer may be formed. The base material may be a porous sheet such as a film and/or a nonwoven fabric made of a resin such as polyolefin (such as polyethylene and polypropylene), polyester, cellulose, polyamide, and/or the like. The functional layer may be an adhesive layer and/or a heat-resistant layer, for example. The adhesive layer can be formed with an adhesive agent, for example. The heat-resistant layer can include a filler and a binder, for example.

The electrolyte may be a non-aqueous electrolyte solution, for example. The non-aqueous electrolyte solution is preferably obtained by adding an electrolyte to a non-aqueous solvent such as an organic solvent. Examples of the electrolyte include one or more from LiPF₆, LiBF₄, LiClO₄, LiFSO₃, LiBOB, and the like. Examples of the non-aqueous solvent include one or more from ethylene carbonate (EC), ethyl methyl carbonate (EMC), dimethyl carbonate (DMC), propylene carbonate (PC), butylene carbonate (BC), diethyl carbonate (DEC), and the like. The non-aqueous electrolyte solution may further include an additive such as vinylene carbonate (VC), vinylethylene carbonate (VEC), fluoroethylene carbonate, and/or the like.

### EXAMPLES

### [Measurement of Average Particle Size D50]

Particle size distribution of graphite particles and Si-containing particles used in Examples and Comparative Examples was measured with a laser diffraction particle size distribution measuring apparatus, and the average particle size D50 was determined. Results are given in Table 1.

### [Evaluation of Powder Density]

The powder density of the Si-containing particles used in Examples and Comparative Examples when uniaxially compacted at a shaping pressure of up to 60 MPa was measured by the procedure described below. Firstly, a certain amount of the powder was placed in a tubular vessel the bottom surface of which had a certain area. Then, with an automatic powder resistivity measuring system (MCP-PD600), the density at the time when the uniaxial shaping pressure reached 60 MPa was measured.

### [Evaluation of Required Shaping Pressure]

In a tubular vessel the bottom surface of which had a certain area, a certain amount of the graphite particles was placed, and with an automatic powder resistivity measuring system MCP-PD600, the load and the displacement when the graphite particles in the vessel were uniaxially compacted were measured. Based on the load required for uniaxially compacting the graphite particles in the vessel to a density of 1.7 g/cm³, the shaping pressure was calculated.

### [Evaluation of Density of Negative Electrode Composite Material Layer]

The negative electrode plate before the compression step and after the compression step was die-cut into a circle having a diameter of 20 mm, and then the mass was measured to calculate the weight of the negative electrode composite material layer per unit area. Then, the thickness of the negative electrode composite material layer was measured. From the weight [mg/10 cm²] of the negative electrode composite material layer per unit area and the thickness [μm] of the negative electrode composite material layer, the compacted density [g/cm³] of the negative electrode composite material layer was calculated.

### [Preparation of Positive Electrode Plate]

As a positive electrode active material, lithium-nickel-cobalt-manganese composite oxide (NCM) was prepared. As a conductive material, acetylene black (AB) was prepared. As a binder, PVDF was prepared. With the use of NMP as solvent, and with the use of the positive electrode active material, the conductive material, and the binder in a mass ratio of (positive electrode active material):(conductive material):binder=100:1:1 (wt %), a positive electrode composite material paste was prepared. The resulting positive electrode composite material paste was applied to a 15-μm aluminum foil sheet, dried, pressed to a certain thickness, and machined into certain dimensions, and thus a positive electrode plate was obtained.

### [Preparation of Test Cell]

A lead was attached to each of the negative electrode plate and the positive electrode plate obtained in Examples and Comparative Examples, and the electrodes were stacked on top of one another with a separator interposed therebetween, and thus an electrode assembly was prepared. The resulting electrode assembly was inserted into an exterior package made of an aluminum-laminated sheet, and a non-aqueous electrolyte was injected into it, followed by sealing the opening of the exterior package, and thus a test cell (a laminated cell) was prepared. The non-aqueous electrolyte was composed of 1 M LiPF₆ as the Li salt and EC/FEC/EMC/DMC=15/5/40/40 (vol. %) as the solvent.

### [Evaluation of Resistance]

In an environment at 25 °C, the test cell adjusted to an SOC of 50% was subjected to charge and discharge at 0.1C/0.2C/0.5C/1C/2C for 10 seconds, and after a lapse of 10 seconds, the values of the voltage and the current were plotted, followed by calculation of the slope, which was regarded as IV resistance [mΩ].

### Example 1

### [Preparation of Negative Electrode Plate]

As Si-containing particles, Si—C composite material particles having the powder density and the average particle size D50 as specified in Table 1 were prepared. As graphite particles, graphite particles having the required shaping pressure and the average particle size D50 as specified in Table 1 were prepared. As a binder, carboxymethylcellulose (CMC), polyacrylic acid (PAA), and styrene-butadiene rubber (SBR) were prepared. As a conductive material, a dispersion of single-walled carbon nanotubes (SWCNTs) was prepared. The graphite particles, the Si-containing particles, CMC, PAA, SBR, and SWCNTs were mixed and kneaded in a mass ratio of (graphite particles):(Si-containing particles):CMC:PAA:SBR:SWCNT=65.0:35.0:1.0:1.0:1.5:0.1 (wt %) by the procedure (1) to (3) described below, and thus a negative electrode composite material paste was prepared.

(1) Graphite, the Si-containing particles, CMC, and PAA were dry-mixed to form a mixed powder.

(2) To the resulting mixed powder, the SWCNT dispersion and a dispersion solvent were added, and the resultant was high-shear kneaded and mixed.

(3) SBR and a dispersion solvent were further added thereto, and dispersed, diluted, and mixed to prepare a negative electrode composite material paste.

The resulting negative electrode composite material paste was applied to a 10 μm copper foil sheet and dried to form a negative electrode composite material layer including an active material which was made of the Si-containing particles and the graphite particles. Then, the resultant was compressed to a certain thickness and machined into certain dimensions to form a negative electrode plate. The content of the silicon-containing particles in the active material, the ratio of the average particle size D50, namely (Graphite particles/si-containing particles), and the density of the negative electrode composite material layer before compression and after compression were given in Table 1.

### Example 2

Except that Si—C composite material particles having the powder density and the average particle size D50 as specified in Table 1 were used as Si-containing particles, graphite particles having the required shaping pressure and the average particle size D50 as specified in Table 1 were used as graphite particles, and a negative electrode composite material paste was prepared by adopting the mass ratio of the graphite particles, the Si-containing particles, CMC, PAA, SBR, and SWCNTs of (graphite particles):(Si-containing particles):CMC:PAA:SBR:SWCNT=72.0:28.0:1.0:1.0:1.5:0.1 (wt %), the same manner as in Example 1 was employed to prepare a negative electrode plate. Results are given in Table 1.

### Example 3

Except that Si—C composite material particles having the powder density and the average particle size D50 as specified in Table 1 were used as Si-containing particles and graphite particles having the required shaping pressure and the average particle size D50 as specified in Table 1 were used as graphite particles, the same manner as in Example 1 was employed to prepare a negative electrode plate. Results are given in Table 1.

### Comparative Example 1

Except that Si—C composite material particles having the powder density and the average particle size D50 as specified in Table 1 were used as Si-containing particles, graphite particles having the required shaping pressure and the average particle size D50 as specified in Table 1 were used as graphite particles, and the mass ratio of the graphite particles, the Si-containing particles, CMC, PAA, SBR, and SWCNTs was (graphite particles):(Si-containing particles):CMC:PAA:SBR:SWCNT=51.0:49.0:1.0:1.0:1.5:0.1 (wt %), the same manner as in Example 1 was employed to prepare a negative electrode plate. Results are given in Table 1.

### Comparative Example 2

Except that Si—C composite material particles having the powder density and the average particle size D50 as specified in Table 1 were used as Si-containing particles, graphite particles having the required shaping pressure and the average particle size D50 as specified in Table 1 were used as graphite particles, and the mass ratio of the graphite particles, the Si-containing particles, CMC, PAA, SBR, and SWCNTs was (graphite particles):(Si-containing particles):CMC:PAA:SBR:SWCNT=75.0:25.0:1.0:1.0:1.5:0.1 (wt %), the same manner as in Example 1 was employed to prepare a negative electrode plate. Results are given in Table 1.

### Comparative Example 3

Except that Si—C composite material particles having the powder density and the average particle size D50 as specified in Table 1 were used as Si-containing particles, graphite particles having the required shaping pressure and the average particle size D50 as specified in Table 1 were used as graphite particles, and the mass ratio of the graphite particles, the Si-containing particles, CMC, PAA, SBR, and SWCNTs was (graphite particles):(Si-containing particles):CMC:PAA:SBR:SWCNT=70.0:30.0:1.0:1.0:1.5:0.1 (wt %), the same manner as in Example 1 was employed to prepare a negative electrode plate. Results are given in Table 1.

TABLE 1

| | | | | | | | Ratio of | | | |
|---|---|---|---|---|---|---|---|---|---|---|
| | | | | | Content | | average | | | |
| | | | | | of Si- | Si | particle | | | |
| | Si-containing | | | | con- | content | size D50 | Density of negative | | |
| | particles | | Graphite particles | | taining | of Si- | (graphite | electrode composite | | |
| | | Average | Required | Average | particles | con- | particles/ | material layer [g/cm³] | | |
| | Powder | particle | shaping | particle | in active | taining | Si- | Before | After | |
| | density | size D50 | pressure | size D50 | material | particles | containing | com- | com- | Resistance |
| | [g/cm³] | [μm] | [MPa] | [μm] | [mass %] | [mass %) | particles) | pression | pression | [mΩ] |
| Ex. 1 | 0.80 | 8 | 45 | 18 | 35 | 50 | 2.25 | 0.99 | 1.40 | 94 |
| Ex. 2 | 0.75 | 9 | 40 | 20 | 28 | 40 | 2.22 | 0.98 | 1.43 | 98 |
| Ex. 3 | 0.85 | 7 | 45 | 18 | 35 | 30 | 2.57 | 0.99 | 1.43 | 99 |
| Comp | 1.00 | 2 | 20 | 19 | 49 | 55 | 9.50 | 0.99 | 1.47 | 112 |
| Ex. 1 | | | | | | | | | | |
| Comp. | 1.30 | 4 | 45 | 14 | 25 | 50 | 3.50 | 0.98 | 1.46 | 106 |
| Ex. 2 | | | | | | | | | | |
| Comp | 0.75 | 9 | 20 | 16 | 30 | 45 | 1.78 | 0.99 | 1.46 | 109 |
| Ex. 3 | | | | | | | | | | |

The resistance in Examples 1 to 3 was less than that in Comparative Examples 1 to 3. It indicates that the present disclosure provides a negative electrode plate for a non-aqueous electrolyte secondary battery in which an increase of resistance is reduced, as well as a method of producing the same.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A negative electrode plate for a non-aqueous electrolyte secondary battery, the negative electrode plate comprising:
a negative electrode composite material layer, wherein
the negative electrode composite material layer includes an active material,
the active material includes silicon-containing particles and graphite particles,
a content of the silicon-containing particles in the active material relative to a total mass of the active material is from 10 to 60 mass %,
the silicon-containing particles have a powder density of 0.90 g/cm³ or less when uniaxially compacted at a shaping pressure of up to 60 MPa, and
a shaping pressure required for uniaxially compacting the graphite particles to a density of 1.7 g/cm³ is 30 MPa or more.

2. The negative electrode plate for a non-aqueous electrolyte secondary battery according to claim 1, wherein a ratio of an average particle size D50 of the graphite particles to an average particle size D50 of the silicon-containing particles is from 1.00 to 8.00.

3. The negative electrode plate for a non-aqueous electrolyte secondary battery according to claim 1, wherein an average particle size D50 of the graphite particles is from 5 to 25 μm, and an average particle size D50 of the silicon-containing particles is from 2 to 25 μm.

4. The negative electrode plate for a non-aqueous electrolyte secondary battery according to claim 1, wherein a content of the graphite particles in the active material relative to the total mass of the active material is from 40 to 85 mass %.

5. The negative electrode plate for a non-aqueous electrolyte secondary battery according to claim 1, wherein a silicon content of the silicon-containing particles is from 20 mass % to 60 mass %.

6. The negative electrode plate for a non-aqueous electrolyte secondary battery according to claim 1, wherein the negative electrode composite material layer has a density of 1.3 g/cm³ or more.

7. A non-aqueous electrolyte secondary battery comprising the negative electrode plate for a non-aqueous electrolyte secondary battery according to claim 1.

8. A method of producing a negative electrode plate for a non-aqueous electrolyte secondary battery, the method comprising:
compressing a negative electrode composite material layer including an active material, wherein
the active material includes silicon-containing particles and graphite particles,
a content of the silicon-containing particles in the negative electrode composite material layer relative to a total mass of the active material is from 10 to 60 mass %,
the silicon-containing particles have a powder density of 0.9 g/cm³ or less when uniaxially compacted at a shaping pressure of up to 60 MPa, and
a shaping pressure required for uniaxially compacting the graphite particles to a density of 1.7 g/cm³ is 30 MPa or more.

9. The method of producing a negative electrode plate for a non-aqueous electrolyte secondary battery according to claim 8, the method further comprising:
preparing a negative electrode composite material paste; and
forming the negative electrode composite material layer by applying the negative electrode composite material paste to a negative electrode base material and drying.

10. The method of producing a negative electrode plate for a non-aqueous electrolyte secondary battery according to claim 8, wherein a ratio of an average particle size D50 of the graphite particles to an average particle size D50 of the silicon-containing particles is from 1.00 to 8.00.

11. The method of producing a negative electrode plate for a non-aqueous electrolyte secondary battery according to claim 8, wherein an average particle size D50 of the graphite particles is from 5 to 25 μm, and an average particle size D50 of the silicon-containing particles is from 2 to 25 μm.

12. The method of producing a negative electrode plate for a non-aqueous electrolyte secondary battery according to claim 8, wherein a content of the graphite particles in the active material relative to the total mass of the active material is from 40 to 85 mass %.

13. The method of producing a negative electrode plate for a non-aqueous electrolyte secondary battery according to claim 8, wherein a silicon content of the silicon-containing particles is from 20 mass % to 60 mass %.
